(19) United States
(12) Patent Application Publication
(10) Pub. No.: US 2017/0300205 A1
(43) Pub. Date: Oct. 19, 2017

(54) METHOD AND APPARATUS FOR PROVIDING DYNAMICALLY POSITIONED CONTROLS

(71) Applicant: QUALCOMM Incorporated, San Diego, CA (US)

(72) Inventors: Andrea Villa, San Diego, CA (US); Arthur Pajak, San Diego, CA (US); Chad Willkie, Cardiff by the Sea, CA (US); Robyn Oliver, San Diego, CA (US)

(21) Appl. No.: 15/477,814

(22) Filed: Apr. 3, 2017

Related U.S. Application Data
(60) Provisional application No. 62/323,579, filed on Apr. 15, 2016.

(51) Int. Cl. G06F 3/0484; G06F 3/0481; G06F 3/0482; G06F 3/0488

(52) U.S. Cl. CPC G06F 3/0484; G06F 3/0488; G06F 3/04817; G06F 3/0482

(57) ABSTRACT

Methods and apparatuses for providing dynamically positioned UI controls are disclosed. In one aspect, the method comprises performing a calibration a client device to facilitate ergonomic placement of at least one control element associated with a virtual control on the display. Calibration comprises prompting a user to grip the device in a first orientation. Then one or more grip locations at which the device is being gripped while in the first orientation are detected. The calibration also comprises prompting the user to touch a region of the display while maintaining the orientation and the grip. A touch input is detected within the display region subsequent to the prompting. Then, subsequent to the calibration, the at least one control element can be displayed on the display based on the calibration.

### TECHNICAL FIELD

The present application relates generally to user interface (UI) configurations for touchscreen devices, and more specifically to methods and systems for calibrating these devices and providing dynamically positioned UI controls for these devices.

### BACKGROUND

Mobile communication devices, such as digital cameras or mobile phones, often include touchscreen displays by which a user may both control the mobile device and also view subject matter being processed by the mobile device. In some instances, a user may desire to operate the mobile devices with a single hand, for example while performing other tasks simultaneously or while utilizing a feature of the mobile device (e.g., endeavoring to capture a “selfie” with a digital camera or similar device). However, as the mobile devices increase in size, such single handed operation may be increasingly difficult to safely and comfortable accomplish. This may be due to UI controls that are improperly or inconveniently located for single handed operation. For example, the UI controls may be statically located and, thus, may not be convenient for users with different hand sizes to operate single handedly or for users to utilize in varying orientations or with varying grips. In this context, there remains a need for calibrating the UI of the mobile device and generating and/or providing UI controls that are dynamically positioned based on a comfortable position or location of the user's finger or control object while holding and/or operating the mobile device.

### SUMMARY

The systems, methods and devices of this disclosure each have several innovative aspects, no single one of which is solely responsible for the desirable attributes disclosed herein.

In one aspect, there is provided a method, operable by a client device, for placing a virtual control on a touch-sensitive display of the device. The method comprises performing a calibration of the client device to facilitate ergonomic placement of at least one control element associated with the virtual control on the display. The performing of the calibration comprises prompting a user of the device to grip the device in a calibration orientation. The performing of the calibration further comprises detecting one or more grip locations on the device, or detecting a calibration grip, at which the device is being gripped while the device is in the calibration orientation during the calibration. The performing of the calibration also comprises prompting the user to touch a region of the display while maintaining the calibration orientation and the calibration grip. The performing of the calibration also further comprises detecting a touch input within the region subsequent to the prompting. The method further comprises detecting a post-calibration grip on the device. The method further comprises displaying the at least one control element at a location of the display based on the performed calibration and the detected post-calibration grip.

In another aspect, there is provided an apparatus configured to place a virtual control on a touch-sensitive display of a client device. The apparatus comprises at least one sensor configured to detect one or more inputs based on a user's grip and orientation of the device. The apparatus further comprises a processor configured to perform a calibration of the device to facilitate ergonomic placement of at least one control element associated with the virtual control on the display. The processor is configured to prompt the user of the device to grip the device in a calibration orientation. The processor is further configured to determine a calibration grip, based on the one or more inputs detected by the at least one sensor, while the device is in the calibration orientation during the calibration subsequent to the prompt of the user to grip the device. The processor is also configured to prompt the user to touch a region of the display while maintaining the calibration orientation and the calibration grip. The processor is also configured to further detect a touch input within the region subsequent to the prompt of the user to touch the region of the display. The processor is further configured to also detect a post-calibration grip on the device subsequent to the calibration of the device and display the at least one control element at a location of the display, wherein the location is based on the performed calibration and the detected post-calibration grip.

In an additional aspect, there is provided another apparatus configured to place a virtual control on a touch-sensitive display of a client device. The apparatus comprises means for performing a calibration of the device to facilitate ergonomic placement of at least one control element associated with the virtual control on the display. The apparatus also comprises means for prompting a user of the device to hold the device in a calibration orientation and means for detecting a calibration grip while the device is in the calibration orientation during the calibration subsequent to the prompting the user to hold the device. The apparatus further comprises means for prompting the user to touch a region of the display while maintaining the calibration orientation and the calibration grip and means for detecting a touch input within the region subsequent to the prompting the user to touch the region of the display. The apparatus also further comprises means for detecting a post-calibration grip on the device. The apparatus further also comprises means for displaying the at least one control element at a location of the display, wherein the location is based on the performed calibration and the detected post-calibration grip.

In an additional aspect, there is provided non-transitory, computer-readable storage medium. The non-transitory, computer readable medium comprises code executable to perform a calibration of the device to facilitate ergonomic placement of at least one control element associated with the virtual control on the display. The medium further comprises code executable to prompt a user of the device to hold the device in a calibration orientation and detect a calibration grip while the device is in the calibration orientation during the calibration subsequent to the prompting the user to hold the device. The medium also comprises code executable to prompt the user to touch a region of the display while maintaining the calibration orientation and the calibration grip and detect a touch input within the region subsequent to the prompting the user to touch the region of the display. The medium also comprises code executable to detect a post-calibration grip on the device and display the at least one control element at a location of the display, wherein the location is based on the performed calibration and the detected post-calibration grip.

### BRIEF DESCRIPTION OF THE DRAWINGS

FIG. 1 is an example of a scenario of operating a mobile device (e.g., a mobile communication device) having camera functionality and a display screen with one hand where user interface (UI) action elements (e.g., buttons) are difficult or inconvenient to reach during one-handed operation, in accordance with aspects of this disclosure.

FIG. 2A illustrates an example of an apparatus (e.g., a mobile communication device) that includes an imaging system that can record images of a scene in accordance with aspects of this disclosure.

FIG. 2B is a block diagram illustrating an example of the mobile communication device of FIG. 2A in accordance with aspects of this disclosure.

FIG. 3 is an example of a scenario of operating the mobile communication device of FIG. 2B with a camera application with one hand where the original UI buttons are still difficult or inconvenient to reach during one-handed operation but where additional dynamic buttons are generated based on a position of one or more control objects of a user, in accordance with aspects of this disclosure.

FIG. 4 is an example of a scenario of operating the mobile communication device of FIG. 2B without any active applications (e.g., from a home screen) with one hand where one or more original UI buttons are difficult or inconvenient to reach during one-handed operation but where additional dynamic buttons are generated based on a position of one or more control objects and/or a grip of a user's hand, in accordance with aspects of this disclosure.

FIG. 5 is an example of a scenario of operating the mobile communication device of FIG. 2B with a music player application with one hand where one or more original UI buttons are difficult or inconvenient to reach during one-handed operation but where additional dynamic buttons are generated based on a position of one or more control objects and/or a grip of a user's hand, in accordance with aspects of this disclosure.

FIG. 6 is an example of view of touchscreen portion of the mobile communication device of FIG. 2B that indicates how menus and/or dynamic buttons may be displayed dependent upon a position of one or more control objects of a user's hand, in accordance with aspects of this disclosure.

FIG. 7A is a flowchart illustrating an example method operable by a mobile communication device in accordance with aspects of this disclosure.

FIG. 7B is a flowchart illustrating another example method operable by a mobile communication device in accordance with aspects of this disclosure.

FIG. 8A depicts a user using a mobile communication device, where the user's hand is able to access a majority of a touchscreen of the mobile communication device, in accordance with aspects of this disclosure.

FIG. 8B depicts a user using a mobile communication device, where the user's hand is unable to access a majority of a touchscreen of the mobile communication device, in accordance with aspects of this disclosure.

### DETAILED DESCRIPTION

Digital devices or other mobile communication devices (e.g., mobile phone cameras, web cameras on laptops, etc.) may provide or render one or more user interfaces (UIs) on a display to allow users to interface and/or control the mobile devices. For example, on a digital camera, the UI may include a view screen and buttons by which the user may monitor and/or adjust current and/or available settings for the digital camera and/or capture an image or video. On a mobile phone, the UI may allow the user to activate various applications or functions and further allow the user to control various aspects or features of the applications or functions (e.g., focal point, flash settings, zoom, shutter, etc. of a camera application). Accordingly, the user's ability to easily and comfortably use the UI can improve user experience of use of the mobile device.

In some embodiments, the mobile device may comprise various sensors configured to identify one or more positions of fingers (or digits or other similar natural or manmade holding means) in contact with the mobile device. For example, the sensors may identify that the mobile device is being held at three points (e.g., a top, a side, and a bottom). Furthermore, in some embodiments, the mobile device may comprise sensors configured to detect one or more positions of fingers in close proximity with the mobile device. For example, close proximity may correspond to being within a distance of 1 centimeter (cm) or 1 inch (in) from the mobile device. Thus, using the sensors described herein, the mobile device may determine locations of the fingers of the hand or hands used to hold and manipulate the mobile device. Accordingly, one or more processors of the mobile communication device may use the information regarding these locations to dynamically adjust positions of various elements of the UI to enable comfortable and simple access and use by the user. For example, buttons integrated into the view screen may be positioned or relocated based on determined locations of the fingers of the user's hand so the user can easily actuate or access the buttons.

Such dynamic adjustment and positioning of the UI controls may utilize one or more dynamic UI techniques or techniques that utilize the information from the one or more sensors (e.g., a grip sensor) to determine how and where the mobile device is being held by the user. The dynamic UI techniques may also utilize information from sensors that detect one or more fingers positioned above the view screen of the mobile device to determine where relocated buttons should be positioned for convenient access by the user's finger(s).

The grips sensor may be configured to determine where and how the mobile device is held by the user. For example, the grip sensor may comprise one or more non-touch capacitive, resistive, ultrasound, ultrasonic, etc. sensors configured to detect and identify points of contact between an exterior surface of the mobile device and the hand of the user.

The finger sensor may be configured to identify a position of a finger or other pointing or actuating device used by the user to interact with the view screen of the mobile device (e.g., where the view screen is a touchscreen such as a touch-sensitive display or similar input/output device). For example, the finger sensor may comprise one or more non-touch capacitive, resistive, ultrasound, ultrasonic, etc. sensors configured to determine when the finger or pointing device is “hovering” above the view screen but not in actual contact with the view screen. The finger or pointing device may be hovering above the view screen when the finger or pointing device is within a specified distance from the view screen for at least a specified period of time. For example, the specified distance may be less than one inch or one centimeter and the specified period of time may be 0.5 seconds or 1 second.

There are a number of variations of a dynamic UI technique for generating a hover menu. For example, the dynamic UI technique may include instructions or code for causing one or more processors of a device to generate buttons for the hover menu based on applications that are or are not active on the mobile device. Thus, the dynamically positioned buttons of the hover menu may be associated with commands presented for a currently active application or program.

The following detailed description is directed to certain specific embodiments. However, the described technology can be embodied in a multitude of different ways. It should be apparent that the aspects herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein.

Further, the systems and methods described herein may be implemented on a variety of different portable computing devices. These include may include, for example, mobile phones, tablets, etc., and other hand-held devices.

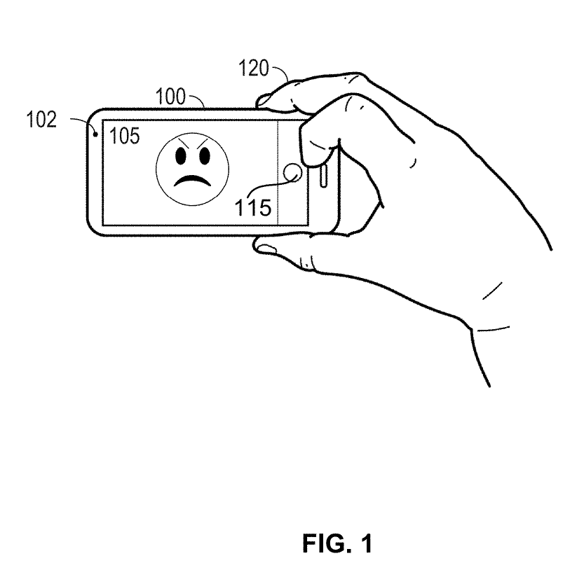

FIG. 1 shows an example of a scenario where a user operates a mobile communication device 100 having camera functionality and a display screen 105 with hand 120 where a button 115, illustrated here as an image capture button, is difficult or inconvenient to reach during one-handed operation, in accordance with aspects of this disclosure. As shown, the mobile communication device 100 is held by one hand, hand 120, and displays the user's face on the display screen 105 as captured by a camera lens 102. The display screen 105 is also shown displaying a shutter control or image capture button 115 to be actuated by the user.

The user may use the mobile communication device 100 (e.g., a mobile phone with an integrated camera) to capture an image of the user (e.g., a “selfie”). Accordingly, the user may hold the mobile communication device 100 with the hand 120 (such as the right hand) to maximize a distance between the mobile communication device 100 and the user, or because the user intends to gesture with the other hand (such as a left hand). As shown, when holding the mobile communication device 100 with the hand 120, one or more fingers of the hand 120 may be positioned at various points along the mobile communication device 100. Additionally, at least one finger of the hand 120 may be positioned above or near the display screen 105.

In so holding the mobile communication device 100 with the hand 120, the button 115 may be difficult for the user to actuate or access with the hand 120 given how the hand 120 must hold the mobile communication device 100 for stable and safe operation. Accordingly, the user may lose the grip on the mobile communication device 100 or may shake or otherwise move the mobile communication device 100 while attempting to actuate or access the button 115 with the hand 120 and may thus damage the mobile communication device 100 or fail to capture a desired scene due to the movement. Due to this difficulty in comfortably reaching the button 115, the display screen 105 shows the user's agitated expression as captured by the camera lens 102.

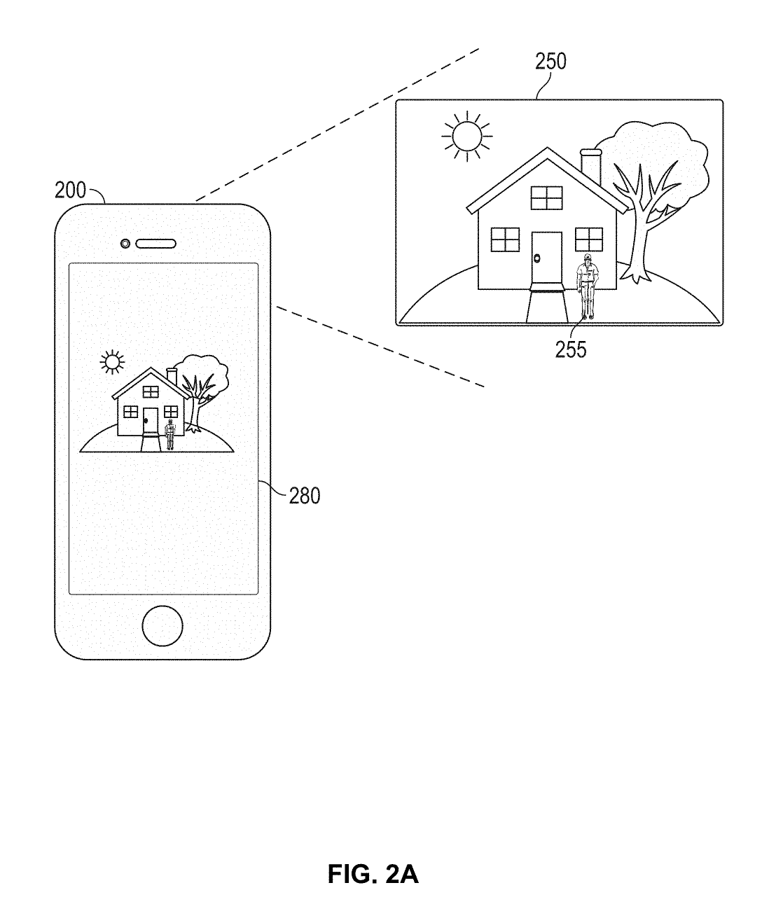

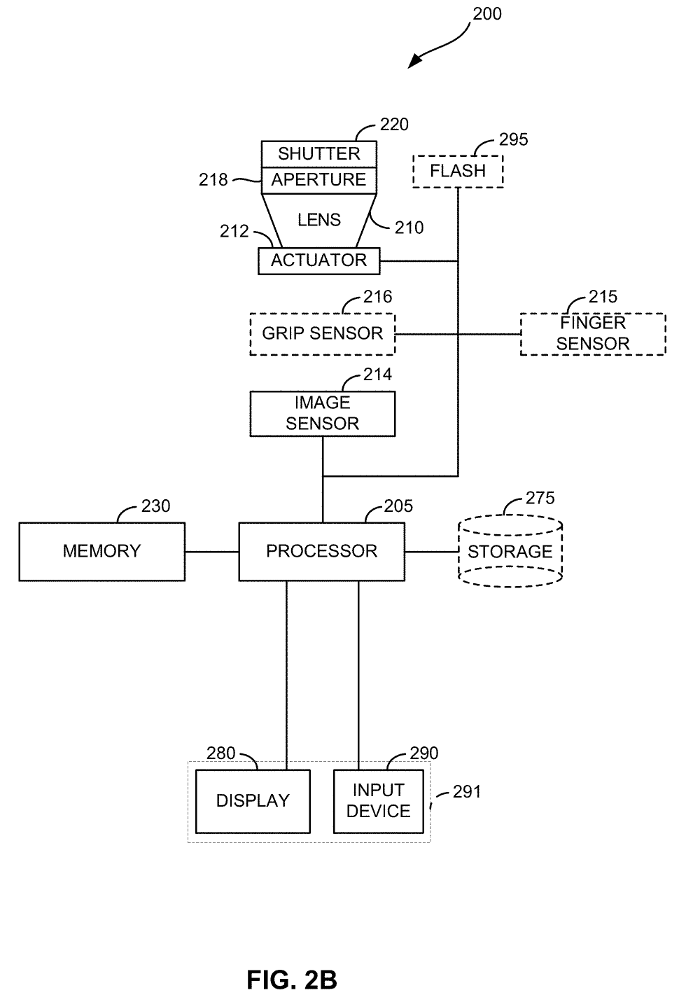

FIG. 2A illustrates an example of mobile communication device 200 (e.g., a mobile device, such as a mobile phone or smart phone) that includes an imaging system that can record images of a scene in accordance with aspects of this disclosure. The mobile communication device 200 includes a display 280. The mobile communication device 200 may also include a camera on the reverse side of the mobile communication device 200, which is not shown. The display 280 may display images captured within a field of view 250 of the camera. FIG. 2A shows an object 255 (e.g., a person) within the field of view 250 which may be captured by the camera. A processor within the mobile communication device 200 may dynamically adjust the UI based on how a user is holding the mobile communication device 200 to ensure ease and comfort of use when capturing an image of the field of view 250 of the camera.

The mobile communication device 200 may perform various automatic processes to dynamically adjust the UI to position the UI controls prior to capture of the image. In one aspect, the mobile communication device 200 may perform dynamic UI positioning based on positions of the user's fingers. Aspects of this disclosure may relate to techniques which allow a user of the mobile communication device 200 to select one or regions of the display 280 within which dynamic UI controls may be enabled or disabled (e.g., regions where the user does or does not want dynamic UI buttons to be placed).

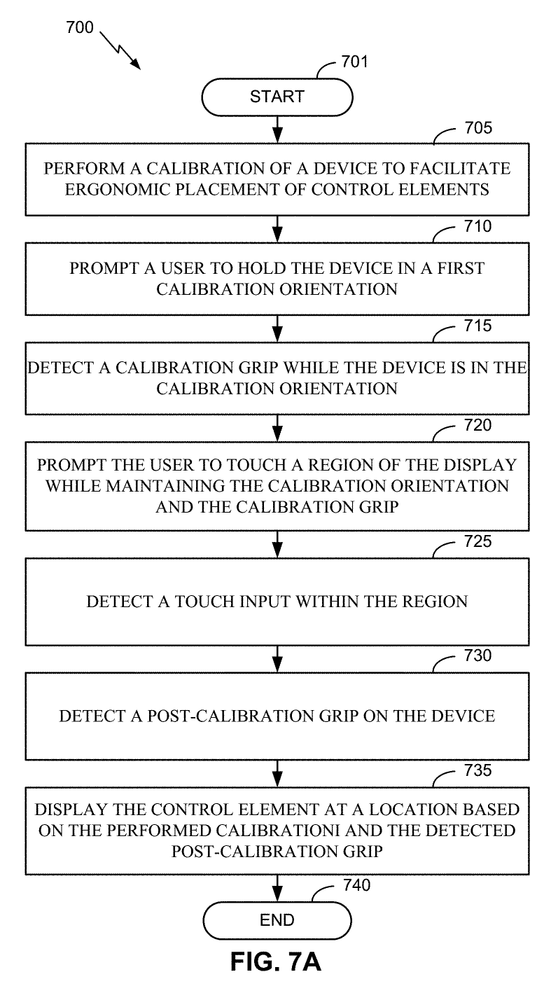

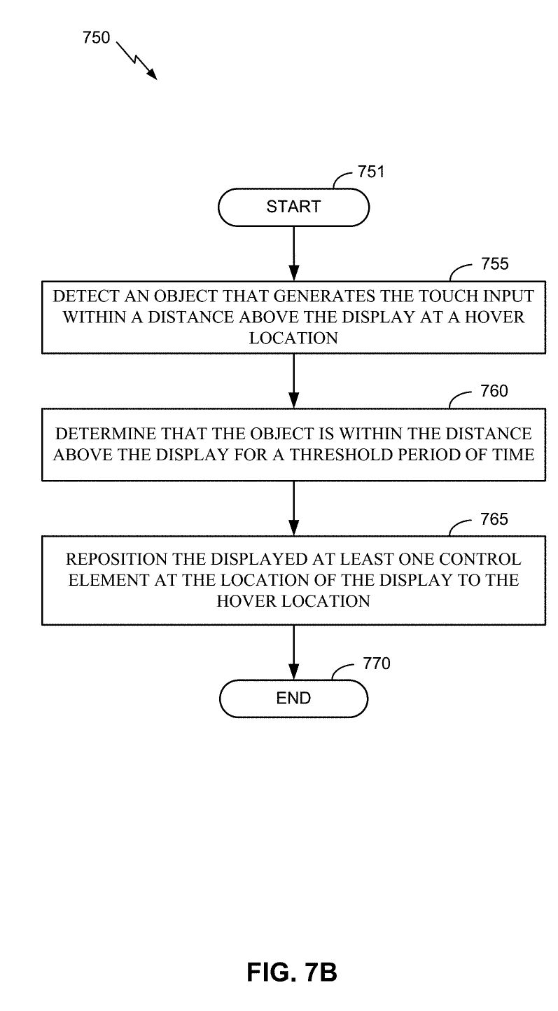

FIG. 2B depicts a block diagram illustrating an example of components that may form an imaging system of the mobile communication device 200 of FIG. 2A in accordance with aspects of this disclosure. The mobile communication device 200 may comprise the imaging system, also referred herein to interchangeably as a camera. The imaging system may include a processor 205 operatively connected to an image sensor 214, a finger sensor 215, a grip sensor 216, a lens 210, an actuator 212, an aperture 218, a shutter 220, a memory 230, a storage 275, a display 280, an input device 290, and an optional flash 295. In some implementations, memory 230 and storage 275 may include the same memory/storage device in mobile communication device 200. Grip sensor 216 is capable of determining different aspects of the user's grip of a mobile communication device 200 including, for example, number of fingers holding the device, whether a palm is touching the device, the strength of the grip, etc. Although referred to herein in the singular, it is understood that a grip sensor 216 may include multiple sensors placed along a device. Furthermore, it is understood that determining a grip can include integrating information from grip sensor 216 as well as other sensors in the mobile communication device 200. It is understood that the mobile communication device 200 can additionally or alternatively include at least one sensor configured to detect one or more inputs based on the user's grip and orientation of the device. Such sensors can include grip sensor 216, gyroscope, accelerometer, magnetometer, infrared sensor, ultrasound sensor, and/or proximity sensor. Additionally or alternatively, a camera or image sensor may also be used to determine the orientation of the device relative to, for example, a face of a user. In this example, the illustrated memory 230 may store instructions to configure processor 205 to perform functions relating to the imaging system, for example, the method 700 of FIG. 7A. In some embodiments, the processor 205 and the memory 230 may perform functions of the imaging system and the mobile communication device 200. In this example, the memory 230 may include instructions for instructing the processor 205 to implement a dynamic UI technique in accordance with aspects of this disclosure.

In an illustrative embodiment, light enters the lens 210 and is focused on the image sensor 214. In some embodiments, the lens 210 is part of an auto focus lens system which can include multiple lenses and adjustable optical elements. In one aspect, the image sensor 214 utilizes a charge coupled device (CCD). In another aspect, the image sensor 214 utilizes either a complementary metal-oxide semiconductor (CMOS) or CCD sensor. The lens 210 is coupled to the actuator 212 and may be moved by the actuator 212 relative to the image sensor 214. The actuator 212 is configured to move the lens 210 in a series of one or more lens movements during an auto focus operation, for example, adjusting the lens position to change the focus of an image. When the lens 210 reaches a boundary of its movement range, the lens 210 or actuator 212 may be referred to as saturated. In an illustrative embodiment, the actuator 212 is an open-loop voice coil motor (VCM) actuator. However, the lens 210 may be actuated by any method known in the art including a closed-loop VCM, Micro-Electronic Mechanical System (MEMS), or a shape memory alloy (SMA).

In certain embodiments, the mobile communication device 200 may include a plurality of image sensors similar to image sensor 214. Each image sensor 214 may have a corresponding lens 210 and/or aperture 218. In one embodiment, the plurality of image sensors 214 may be the same type of image sensor (e.g., a Bayer sensor). In this implementation, the mobile communication device 200 may simultaneously capture a plurality of images via the plurality of image sensors 214, which may be focused at different focal depths. In other embodiments, the image sensors 214 may include different image sensor types that produce different information about the captured scene. For example, the different image sensors 214 may be configured to capture different wavelengths of light (infrared, ultraviolet, etc.) other than the visible spectrum.

The finger sensor 215 may be configured to determine a position at which one or more fingers are positioned above, but in proximity with the display 280 of the mobile communication device 200. The finger sensor 215 may comprise a plurality of sensors positioned around the display 280 of the mobile communication device 200 and configured to detect the finger or pointing device positioned above a location of the display 280. For example, the finger sensor 215 may comprise a non-touch, capacitive sensor to detect a finger or other pointing device that is positioned above the display 280. In some embodiments, the finger sensor 215 may couple to the processor 205, which may use the information identified by the finger sensor 215 to determine where dynamic UI controls should be positioned to allow ease and comfort of access to the user. In some embodiments, information from other sensors of the mobile communication device 200 (e.g., orientation sensors, grip sensors, etc.), may be further incorporated with the finger sensor 215 information to provide more detailed information regarding how and where the finger or pointing device is hovering above the display 280 in relation to how it is being held.

The grip sensor 216 may be configured to determine a position (or multiple positions or locations) at which the mobile communication device 200 is held. For example, the grip sensor 216 may comprise a force resistive sensor or an ultrasound detection sensor. In some embodiments, the grip sensor 216 may couple to the processor 205, which may use the information identified by the grip sensor 216 to determine how the mobile communication device 200 is being held (e.g., what fingers at what locations of the mobile communication device 200). In some embodiments, information from other sensors of the mobile communication device 200 (e.g., orientation sensors, etc.), may be further incorporated with the grip sensor 216 information to provide more detailed information regarding how and where the mobile communication device 200 is being held whether before, during, or after calibration.

The display 280 is configured to display images captured via the lens 210 and the image sensor 214 and may also be utilized to implement configuration functions of the mobile communication device 200. In one implementation, the display 280 can be configured to display one or more regions of a captured image selected by a user, via an input device 290, of the mobile communication device 200.

The input device 290 may take on many forms depending on the implementation. In some implementations, the input device 290 may be integrated with the display 280 so as to form a touchscreen 291. In other implementations, the input device 290 may include separate keys or buttons on the mobile communication device 200. These keys or buttons may provide input for navigation of a menu that is displayed on the display 280. In other implementations, the input device 290 may be an input port. For example, the input device 290 may provide for operative coupling of another device to the mobile communication device 200. The mobile communication device 200 may then receive input from an attached keyboard or mouse via the input device 290. In still other embodiments, the input device 290 may be remote from and communicate with the mobile communication device 200 over a communication network, e.g., a wireless network or a hardwired network. In yet other embodiments, the input device 290 may be a motion sensor which may receive input via tracking of the changing in position of the input device in three dimensions (e.g., a motion sensor used as input for a virtual reality display). The input device 290 may allow the user to select a region of the display 280 via the touchscreen 291 via an input of a continuous or substantially continuous line/curve that may form a curve (e.g., a line), a closed loop, or open loop, or a selection of individual inputs. In some embodiments, the touchscreen 291 comprises a plurality of touch sensitive elements that each corresponds to a single location of the touchscreen 291.

The memory 230 may be utilized by the processor 205 to store data dynamically created during operation of the mobile communication device 200. In some instances, the memory 230 may include a separate working memory in which to store the dynamically created data. For example, instructions stored in the memory 230 may be stored in the working memory when executed by the processor 205. The working memory may also store dynamic run time data, such as stack or heap data utilized by programs executing on processor 205. The storage 275 may be utilized to store data created by the mobile communication device 200. For example, images captured via image sensor 214 may be stored on storage 275. Like the input device 290, the storage 275 may also be located remotely, i.e., not integral with the mobile communication device 200, and may receive captured images via the communication network.

The memory 230 may be considered a computer readable medium and stores instructions for instructing the processor 205 to perform various functions in accordance with this disclosure. For example, in some aspects, memory 230 may be configured to store instructions that cause the processor 205 to perform method 700, or portion(s) thereof, as described below and as illustrated in FIG. 7A.

In one implementation, the instructions stored in the memory 230 may include instructions for performing dynamic position of UI controls that configure the processor 205 to determine where on the touchscreen 291 the dynamically positioned UI controls are to be generated and/or positioned. The positioning may be determined based on information received from the finger sensor 215 and the grip sensor 216. In some embodiments, calibration information stored in the memory 230 may be further involved with the dynamic position of UI controls. The determined positioning may not include every possible touchscreen 291 position within an entire area of the touchscreen 291, but rather may include only a subset of the possible positions within the area of the touchscreen 291. In some embodiments, the positioning may be further based, at least in part, on the number of UI controls to be dynamically positioned.

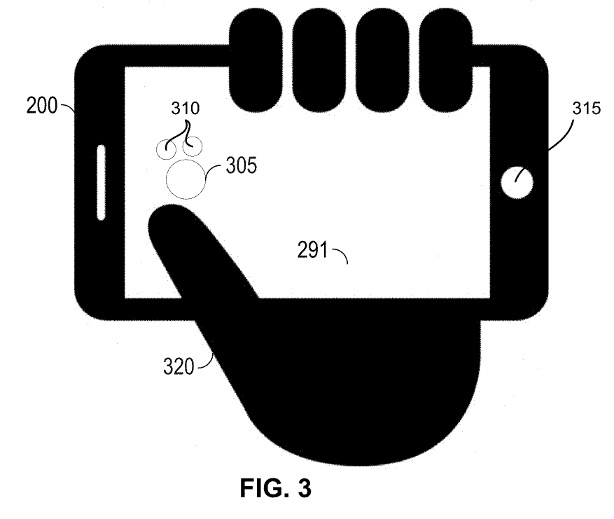

The device 200 may further include an integrated circuit (IC) that may include at least one processor or processor circuit (e.g., a central processing unit (CPU)) and/or a graphics processing unit (GPU), wherein the GPU may include one or more programmable compute units. Examples of various applications of hovering and dynamic positioning of UI controls in accordance with aspects of this disclosure will now be described in connection with FIGS. 3 to 5.

FIG. 3 is an example of a scenario of operating the mobile communication device 200 of FIG. 2B with a camera application with one hand, illustrated as hand 320 where an original UI button 315 is difficult or inconvenient to reach during one-handed operation but where additional dynamic buttons 305 and 310 are generated based on a position of one or more digits of a user's hand, in accordance with aspects of this disclosure. For example, the user may launch or otherwise activate a camera application on the mobile communication device 200. While the camera application is configured to provide the majority of command buttons at the bottom and top of the display while in a portrait mode, rotating the mobile communication device 200 to landscape mode does not relocate positions of UI buttons but rather just rotates them so they are still readable by the user. Accordingly, when being operated with one hand in landscape mode, it may be awkward to access the original UI button 315 controlling a shutter of the mobile communication device 200. Accordingly, the user may active a hover menu, as shown, to allow safer and more comfortable use and access to buttons and commands, e.g., the shutter button.

As shown, the user is holding the mobile communication device 200 with at least two fingers from the user's right hand 320 along a top edge of the mobile communication device 200 (when in landscape orientation) and with a thumb along a bottom edge of the mobile communication device 200. An index finger is shown hovering above the touchscreen 291. The touchscreen 291 shows a scene including various plants. The original UI button 315 is shown on the far right of the touchscreen 291. Accordingly, with the user holding the mobile communication device 200 in his/her hand 320 as shown, it may be difficult or impossible for the user to safely and comfortably access the original UI button 315 without repositioning the mobile communication device 200 in the hand 320.

When the mobile communication device 200 is held as shown in FIG. 3, the finger sensor 215 of FIG. 2B may detect the index finger of the hand 320 positioned above the screen within a specified distance. In some embodiments, the finger sensor 215 may detect when finger(s) or other pointing device(s) enter a space within one centimeter or one inch of the touchscreen 291. The detection of the finger or pointing device may involve the finger sensor 215 sending a finger detection signal to the processor 205, which is running the dynamic UI technique. The processor 205 running the technique may receive the finger detection signal and initiate a timer. The timer may be configured to increment or decrement after being initiated. In some embodiments, the timer may begin at a threshold value and count down; in some embodiments, the time may begin at zero and count up to the threshold value. This threshold value may correspond to the period of time after which the processor 205 determines the finger is hovering as opposed to simply passing over the touchscreen 291. In some embodiments, the threshold period of time may be user defined or predefined and may be user adjustable.

In some embodiments, the finger detection signal sent from the finger sensor 215 to the processor 205 may include information regarding a specific position of the touchscreen 291 over which the finger is detected. For example, the finger sensor 215 may generate or comprise a position signal in relation to the touchscreen 291. For example, the touchscreen 291 may be divided into a (x,y) coordinate plane, and the finger detection signal may include one or more coordinates of the (x,y) coordinate plane above which the finger is hovering. In some embodiments, the finger sensor 215 may comprise a plurality of finger sensors positioned such that different positions above the touchscreen cause different finger sensors to generate the finger detection signal that is transmitted to the processor 205. Accordingly, the processor 205 may be configured to determine if the finger detection signal is received for the threshold amount of time but also if the finger stays in a relative constant location above the touchscreen 291 for the threshold period of time. For example, to determine that the finger is hovering, the processor 205 may determine that the finger is hovering for more than 0.5 seconds within an area of 0.5 square inches of the touchscreen 291.

The processor 205 may also use the position information received as part of the finger detection signal to determine where the hand 320 and/or finger are located. For example, the processor 205 may determine that the finger is hovering above a specific quadrant of the touchscreen 291. This position information may be used to determine how and/or where a hover menu may be generated and/or displayed. For example, when the processor 205 determines that the finger is hovering above a bottom right quadrant of the touchscreen 291, the processor 205 may know to generate or display the hover menu above and/or to the left of the position of the finger to ensure that no portion of the hover menu is cut off by an edge of the touchscreen 291.

Additionally, and/or alternatively, when the mobile communication device 200 is held as shown in FIG. 3, the grip sensor 216 of FIG. 2B may detect the thumb, middle finger, and ring fingers of the hand 320 positioned along the bottom and top edges of the mobile communication device 200. The detection of the fingers (or other supports holding the mobile communication device 200) may involve the grip sensor 216 sending a grip detection signal to the processor 205 that is running the dynamic UI technique for each point of contact identified by the grip sensor 216. The processor 205 running the technique may receive the grip detection signals, and, based on the received grip detection signals, determine how and/or where the mobile communication device 200 is being held by the user's hand 320. In some embodiments, the grip detection signals may include position information (as described above in relation to the finger sensor 215) for each grip detection signal so the processor 205 may determine exact locations of the mobile communication device 200 associated with each grip detection signal received.

Accordingly, in some embodiments, the processor 205 may utilize a combination of the finger detection signal(s) and the grip detection signal(s) to determine how and where to generate or display the hover menu. In some embodiments, the processor 205 may utilize a combination of the received finger and grip detection signals to determine an available reach of the user so as to place all aspects of the hover menu within reach of the user's existing grip. In some embodiments, the processor 205 may receive one or more grip detection signals, and based on the received signal(s), may trigger a monitoring or activation of the finger sensor 215. Thus, the finger detection signal may only be communicated to the processor 205 if the processor 205 has previously determined that the mobile communication device 200 is being held with a particular grip. In some embodiments, the processor 205 may use calibration information (at least in part) to determine where on the touchscreen 291 to generate or display the hover menu so it is in reach of the processor 205. For example, calibration information may correspond to information regarding how far across or what area of the touchscreen 291 the user can access when holding the mobile communication device 200 with a given grip. In some embodiments, the calibration information may be stored in the memory 230 of FIG. 2B.

The hover menu may correspond to a menu of actions or options that is generated or displayed in response to one or more fingers hovering above the touchscreen 291 for the given period of time and within the given area of the touchscreen 291. As shown in FIG. 3, the hover menu may comprise a main command, corresponding to the dynamic button 305, and two option commands, corresponding to the dynamic buttons 310, corresponding to available options associated with the dynamic button 305. The main command may correspond to the main function of the active application, while the option commands may correspond to most common, user selectable, or other static UI commands. In some embodiments, the processor 205 may utilize the finger detection signal(s) and grip detection signal(s) in combination to detect the user's grip hand and hovering finger(s) and determine a location on the touchscreen 291 for the dynamic buttons of the hover menu that is within easy and comfortable reach of the hovering finger(s).

In some embodiments, the hover menu may correspond to a new mode where a number of selected actions are made available to the user via the hover menu, which is positioned in an easy and comfortable to reach location on the touchscreen 291 dependent on the user's grip of the mobile communication device 200 and the user's finger and/or reach above the touchscreen 291. In some embodiments, the selected actions may be chosen based on a currently active application or based on the screen that is active when the hover menu is activated. In some embodiments, the hover menu may place up to four actions associated with a given program or given screen within reach for one handed use by the user.

In some embodiments, the commands and/or options presented in the hover menu may be contextual according to an application or program being run on the mobile communication device 200. For example, as shown in FIG. 3, the hover menu (comprising the buttons 305 and 310) comprises commands and options generally available as part of the camera application on the mobile communication device 200. In some embodiments, the commands and/or options presented as the hover menu may be user selectable based on active applications or independent of active applications. In some embodiments, the commands and/or options of the hover menu may be automatically selected by the processor 205 based on most used commands associated with the active applications or independent of the active applications. In some embodiments, the commands and/or options of the hover menu may correspond with the existing static displayed commands or options associated with the active applications or independent of the active applications.

In some embodiments, hovering detection may always be enabled. In some embodiments, hovering detection may only be enabled in certain modes or when certain apps are running. In some embodiments, hovering detection may be user selectable. In some embodiments, hovering detection may be activated based on an initial grip detection. Accordingly, hovering detection may be dependent upon one or more particular grips that are detected. In some embodiments, where the hover menu includes multiple commands and/or options, the hover menu may be configured to automatically cycle through the multiple commands and/or options. For example, where the dynamic button 305 corresponds to the “main” action or command and the dynamic buttons 310 correspond to the “option” actions or commands, the dynamic button 305 and the dynamic buttons 310 may rotate or cycle such that the user need only be able to access a single position of the touchscreen 291 to access or activate any of the commands or options of the dynamic buttons 305 and 310.

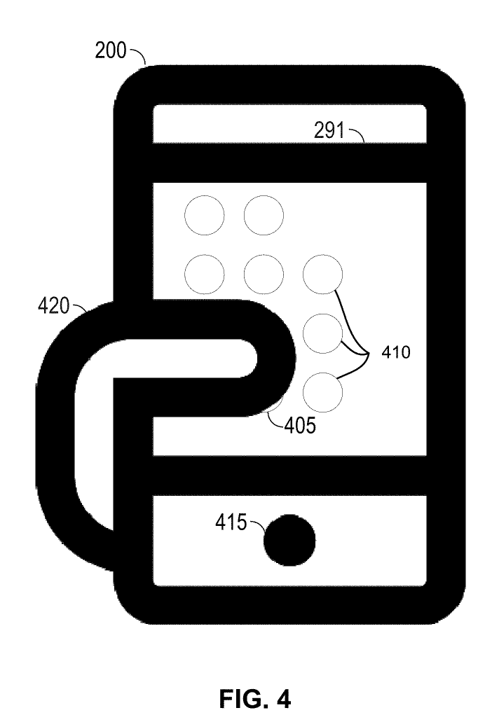

FIG. 4 is an example of a scenario of operating the mobile communication device 200 of FIG. 2B without any active applications (e.g., from a home screen on the touchscreen 291) with one hand 420 where one or more original UI buttons 415 are difficult or inconvenient to reach during one-handed operation but where additional dynamic buttons 405 and 410 are generated based on a position of one or more digits or a grip of the user's hand 420, in accordance with aspects of this disclosure. For example, the user may access the home screen of the mobile communication device 200 via the touchscreen 291 to launch or otherwise activate an application.

Given the portrait orientation of the mobile communication device 200, the user may have difficulties reaching icons for all applications shown on the home screen with the hand 420. Accordingly, the mobile communication device may detect one or more fingers or pointing devices hovering above the touchscreen 291 according as described in relation to FIG. 3. Accordingly, the processor 205 of FIG. 2B of the mobile communication device 200 may generate and display a hover menu comprising the buttons 405 and 410 according to most used applications, user selected applications, applications whose icons are furthest away from the hover position, or any other selection method. In some embodiments, the hover menu may be configured to cycle or rotate through all displayed icons of the home screen or displayed screen if the user's finger is held in the hover position for an extended period of time (e.g., 5 seconds). When the user accesses one of the icons via the hover menu, an application associated with the accessed icon is activated or otherwise run.

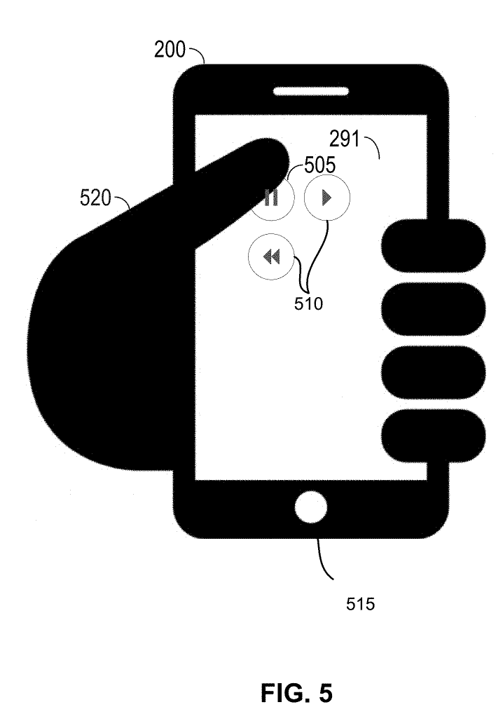

FIG. 5 is an example of a scenario of operating the mobile communication device of FIG. 2B with a music player application with one hand where one or more original UI buttons are difficult or inconvenient to reach during one-handed operation but where additional dynamic buttons are generated based on a position of one or more digits or a grip of a user's hand, in accordance with aspects of this disclosure. For example, the user may launch or otherwise activate a music player application on the mobile communication device 200. While the music player application is configured to provide the majority of command button(s) at the bottom of the touchscreen 291 while in a portrait mode, depending on how the mobile communication device 200 is being held by the user, the original UI button 515 may be difficult to access. Additionally, or alternatively, rotating the mobile communication device 200 to landscape mode may not relocate positions of these UI buttons. Accordingly, when being operated with one hand 520 in either portrait or landscape mode, it may be awkward to access the original UI button 515 controlling the music player application of the mobile communication device 200. Accordingly, the user may active a hover menu, as shown, to allow safer and more comfortable use and access to buttons and commands, e.g., the pause, fast forward, or approve buttons.

The mobile communication device may detect one or more fingers or pointing devices hovering above the touchscreen 291 as described in relation to FIG. 3. Accordingly, the processor 205 of FIG. 2B of the mobile communication device 200 may generate and display a hover menu comprising the buttons 505 and 510 according to the most used commands or options associated with the music player application, user selected commands or options for use with the music player application, the original UI command button 515, or any other selection method. In some embodiments, the hover menu may be configured to cycle or rotate through all displayed options or commands if the user's finger is held in the hover position for an extended period of time (e.g., 5 seconds). When the user accesses one of the commands or actions via the hover menu, an associated action or command is activated.

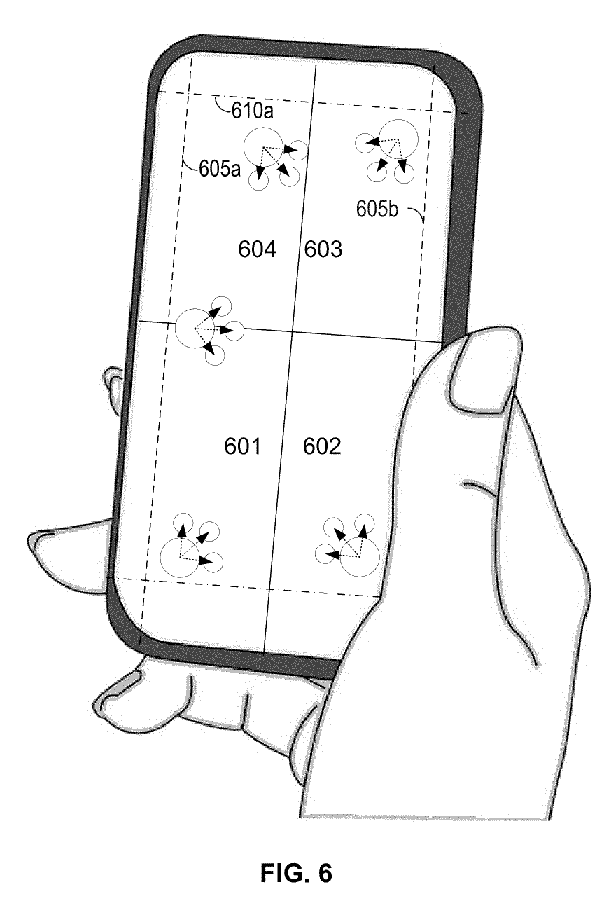

FIG. 6 is an example of view of touchscreen 291 portion of the mobile communication device 200 of FIG. 2B that indicates how menus and/or dynamic buttons may be displayed dependent upon a position of one or more digits of a user's hand, in accordance with aspects of this disclosure. FIG. 6 shows the touchscreen 291 of the mobile communication device 200 of FIG. 2B broken into four quadrants 601, 602, 603, and 604 (counterclockwise from bottom left quadrant 601). The touchscreen 291 also includes vertical edge boundaries 605a and 605b and horizontal edge boundaries 610a and 610b that may indicate edges of the touchscreen 291.

As described herein, the processor 205 of FIG. 2B of the mobile communication device 200 may use the position information received as part of the finger detection signal from the finger sensor 215 of FIG. 2B to determine where the user's hand and/or finger is located. In some embodiments, the processor 205 of the mobile communication device 200 may use the position information received as part of the grip detection signal from the grip sensor 216 of FIG. 2B to determine where the user's hand and/or finger is located. In some embodiments, the finger and grip detection signals may be used in combination (e.g., the grip detection signal may trigger an activation of the finger sensor 215 to generate the finger detection signal). This position information (from one or both of the finger and grip detection signals) may be used to determine how and/or where a hover menu may be generated and/or displayed. For example, when the processor 205 determines (e.g., based on data from one or more touch sensors on the touchscreen device, from the finger sensor 215, and/or from the grip sensor 216) that the finger is hovering above a bottom right quadrant 602 of the touchscreen 291, the processor 205 may determine that the hover menu should be generated above and/or to the left of the position of the finger to ensure that no portion of the hover menu is cut off by a bottom or right edge of the touchscreen 291. Similarly, when the processor 205 determines that the finger is hovering above a bottom left quadrant 601 of the touchscreen 291, the processor 205 may determine that the hover menu should be generated above and/or to the right of the position of the finger to ensure that no portion of the hover menu is cut off by a bottom or left edge of the touchscreen 291. Similarly, when the processor 205 determines that the finger is hovering above a top left quadrant 604 of the touchscreen 291, the processor 205 may determine that the hover menu should be generated below and/or to the right of the position of the finger to ensure that no portion of the hover menu is cut off by a top or left edge of the touchscreen 291. Similarly, when the processor 205 determines that the finger is hovering above a top right quadrant 603 of the touchscreen 291, the processor 205 may determine that the hover menu should be generated below and/or to the left of the position of the finger to ensure that no portion of the hover menu is cut off by the top bottom or right edge of the touchscreen 291.

Similarly, information from the grip detection signals may also be used to determine a location for the hover menu. For example, the grip detection signals may indicate that the mobile communication device 200 is held by the user's right hand along the right edge of the mobile communication device 200 in a landscape mode. Accordingly, the processor 205 may determine that the user likely cannot easily and comfortably reach the far left of the touchscreen 291, and may determine a position for the hover menu. In some embodiments, the grip detection signals may be utilized in a calibration process or procedure, as discussed herein. In such a calibration process or procedure, the grip detection signals may identify how the mobile communication device 200 is held during calibration. In some embodiments, the grip detection signals may indicate which fingers of the user are being used to grip the mobile communication device 200. Subsequent to calibration, the grip detection signals may provide information regarding how the mobile communication device 200 is being held by the user post-calibration, according to which the mobile communication device may manipulate buttons or other control inputs. Similarly, orientation sensors on the mobile communication device 200 can determine or detect a orientation of the mobile communication device 200 post-calibration, referred to as a post-calibration orientation. In some embodiments, the processor 205 may utilize the finger detection signal(s) and grip detection signal(s) in combination to detect the user's grip hand and hovering finger(s) and determine a location on the touchscreen 291 for the hover menu buttons of the hover menu that is within easy and comfortable reach of the hovering finger(s). Furthermore, the processor 205 can additionally use the post-calibration orientation in combination with the signal(s) described above to determine the location on the touchscreen 291 to place the hover menu buttons.

Though specific examples of applications are described herein as benefiting from the hover menu, various other applications may be similarly benefited. For example, a maps or navigation application may comprise a hover menu that can be activated while the maps or navigation application is running to enable simplified, safer, and more comfortable use by the user. Similarly, texting applications, electronic mail applications, games, cooking applications, or any other application with embedded commands or options may benefit from use of hover menus as described herein.

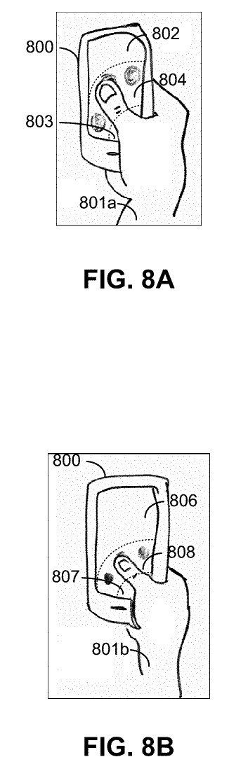

Additionally, as described herein, the finger sensor 215 and grip sensor 216 of FIG. 2B, respectively, may provide various information to the processor 205 of FIG. 2B. For example, the processor 205 may determine a position or orientation of the user's thumb or other fingers based on signals received from the finger sensor 215 and grip sensor 216, respectively. Additionally, the processor 205 may be able to determine and store in the memory 230 of FIG. 2B calibration information, for example different extents or distances of reach of the user based on the user's current grip as determined from calibration processes, as discussed in relation to at least FIGS. 7A, 8A, and 8B below. For example, the processor 205 may be able to determine, via the finger sensor 215 and grip sensor 216, respectively, that when the user holds the mobile communication device in their right hand in landscape mode with the right edge of the mobile communication device touching the user's right palm, the user can reach no more than three inches across the touchscreen. This calibration information may be identified and stored as part of a calibration procedure.

Additionally, or alternatively, the finger sensor 215 may be configured to identify a center point of a hover-tap action, where the hover-tap action is the user access of a command or action indicated in one of the hover menus.

### Example Flowcharts for Providing Dynamic UI Controls

An exemplary implementation of this disclosure will now be described in the context of a dynamic UI control procedure.

FIG. 7A is a flowchart illustrating an example method operable by a mobile communication device 200 of FIG. 2B in accordance with aspects of this disclosure. For example, the steps of method 700 illustrated in FIG. 7A may be performed by a processor 205 of the mobile communication device 200. For convenience, method 700 is described as performed by the processor 205 of the mobile communication device 200.

The method 700 begins at block 701. At block 705, the processor 205 performs a calibration of the mobile communication device 200 to facilitate ergonomic placement of at least one control element associated with a virtual control on the touchscreen 291. In some embodiments, the blocks 710-735 comprise steps or blocks of the calibration of the mobile communication device 200. At block 710, the processor 205 prompts a user of the mobile communication device 200 to hold the mobile communication device 200 in a calibration orientation. At block 715, one or more of the processor 205, the finger sensor 215, and the grip sensor 216 detects a calibration grip while the mobile communication device 200 is in the calibration orientation during the calibration subsequent to the prompting the user to hold the mobile communication device 200.

At block 720, the processor 205 prompts the user to touch a region of the touchscreen 291 while maintaining the calibration orientation and the calibration grip. At block 725, one or more of the processor 205, the finger sensor 215, and the grip sensor 216 detects a touch input within the region subsequent to the prompting the user to touch the region of the touchscreen 291. At block 730, one or more of the processor 205, the finger sensor 215, and the grip sensor 216, subsequent to the calibration of the mobile communication device 200, detects a post-calibration grip on the mobile communication device. At block 735, the processor 205 displays the at least one control element at a location of the touchscreen 291, wherein the location is based on the performed calibration and the detected post-calibration grip. The method ends at block 740. It is understood that, while the calibration above is described with reference to a calibration orientation, two separate calibrations may be performed for multiple orientations, for example two orientations such as a portrait orientation and a landscape orientation. Hence, the calibration performed above may be performed once where at block 710 the user is prompted to hold the mobile communication device 200 in a portrait orientation, and the remaining blocks are subsequently performed, and a second time where at block 710 the user is prompted to hold the mobile communication device 200 in a landscape orientation, and the remaining blocks are subsequently performed. As such, the calibration orientation may comprise one of a portrait, landscape, or other orientation (for example, a diagonal orientation).

FIG. 7B is a flowchart illustrating an example method operable by a mobile communication device 200 of FIG. 2B in accordance with aspects of this disclosure. For example, the steps of method 750 illustrated in FIG. 7B may be performed by a processor 205 of the mobile communication device 200. For convenience, method 750 is described as performed by the processor 205 of the mobile communication device 200. In some embodiments, the steps of the method 750 may be performed after the steps of method 700 are performed. Accordingly, the method 750 may manipulate the placement or positioning of the control elements based on detecting an object hovering or idling above the touchscreen 291.

The method 750 begins at block 751. At block 755, the processor 205 detects a pointing object (e.g., a user finger or other pointing device) that can generate the touch input within a distance from the touchscreen (e.g., touchscreen 291 of FIG. 2B) of the mobile communication device 200. The pointing object may be hovering or idling above a hover location of the touchscreen 291. At block 760, the processor 205 determines that the pointing object is within the distance above the touchscreen 291 at the hover location for a threshold period of time. At block 765, the processor 205 repositions the displayed at least one control element from block 735 of the calibration to the hover location or to a vicinity of the hover location. The method ends at block 770.

A mobile communication apparatus that places a virtual control on a touch-sensitive display of the apparatus may perform one or more of the functions of methods 700 and/or 750, in accordance with certain aspects described herein. In some aspects, the apparatus may comprise various means for performing the one or more functions of methods 700 and/or 750. For example, the apparatus may comprise means for performing a calibration of the apparatus to facilitate ergonomic placement of at least one control element associated with the virtual control on the display. In certain aspects, the means for performing a calibration can be implemented by one or more of the grip sensor 216, the processor 205, the finger sensor 215, and/or the touchscreen 291 of FIG. 2B. In certain aspects, the means for performing a calibration can be configured to perform the functions of block 705 of FIG. 7A. The apparatus may comprise means for prompting a user of the apparatus to hold the apparatus in a calibration orientation. In some aspects, the means for prompting the user to hold the apparatus can be implemented by the processor 205 and/or the touchscreen 291. In certain aspects, the means for prompting a user of the apparatus to hold the apparatus can be configured to perform the functions of block 710 of FIG. 7A. The apparatus may comprise means for detecting a calibration grip while the apparatus is in the calibration orientation during the calibration subsequent to the prompting the user to hold the apparatus. In certain aspects, the means for detecting a calibration grip can be implemented by the processor 205 and/or the grip sensor 216 of FIG. 2B. In certain aspects, the means for detecting a calibration grip can be configured to perform the functions of block 715 of FIG. 7A.

The apparatus may comprise means for prompting the user to touch a region of the display while maintaining the calibration orientation and the calibration grip. In certain aspects, the means for prompting the user to touch the display can be implemented by the touchscreen 291 (including, as noted above, display 280), a speaker of a mobile device (not illustrated), and/or the processor 205. In certain aspects, the means for prompting the user to touch the display can be configured to perform the functions of block 720 of FIG. 7A. The apparatus may comprise means for detecting a touch input within the region subsequent to the prompting the user to touch the region of the display. In certain aspects, the means for detecting a touch can be implemented by the touchscreen 291 (including, as noted above, input device 290) and/or the processor 205. In certain aspects, the means for detecting the touch can be configured to perform the functions of block 725 of FIG. 7A. The apparatus may comprise means for detecting a post-calibration grip on the apparatus. In certain aspects, the means for detecting a post-calibration grip can be implemented by the grip sensors 216, the finger sensors 215, the touchscreen 291, and/or the processor 205. In certain aspects, the means for detecting a post calibration grip can be configured to perform the functions of block 730 of FIG. 7A. The apparatus may comprise means for displaying the at least one control element at a location of the display, wherein the location is based on the performed calibration and the detected post-calibration grip. In certain aspects, the means for displaying can be implemented by the display 280, and/or the processor 205. In certain aspects, the means for displaying can be configured to perform the functions of block 735 of FIG. 7A.

In some implementations, the apparatus may further comprise means for detecting a pointing object within a distance from the touchscreen. In some certain aspects, the means for detecting a pointing object can be implemented by the touchscreen 291, various sensors (not shown), and/or the processor 205. In certain aspects, the means for detecting a pointing object can be configured to perform the functions of block 755 of FIG. 7B. The apparatus may further comprise means for determining that the object is within the distance above the display for a threshold period of time. In some certain aspects, the means for determining that the object is within the distance can be implemented by the touchscreen 291, the various sensors (not shown), and/or the processor 205. In certain aspects, the means for determining that the object is within the distance can be configured to perform the functions of block 760 of FIG. 7B. The apparatus may further comprise means for repositioning the displayed at least one control element at the location of the display to the hover location. In some certain aspects, the means for repositioning can be implemented by the touchscreen 291 and/or the processor 205. In certain aspects, the means for repositioning can be configured to perform the functions of block 765 of FIG. 7B. In some aspects, the means for repositioning may move control elements from areas outside a reachable area to within the reachable area. In some aspects, the means for repositioning may further move control elements from anywhere on the touchscreen 291 (e.g., either inside or outside the reachable area) to a position below or near the detected object. Such repositioning of control elements may simplify use of the apparatus by moving control elements to the user (e.g., the object) for easier user access as opposed to requiring the user to find and access the control elements.

FIGS. 8A and 8B depict a first embodiment (8A) of a first user using a device 800, where the first user's hand 801a is able to access a majority of a touchscreen of the device 800 and a second embodiment (8B) of a second user using the device 800, where the second user's hand 801b is unable to access a majority of the touchscreen of the device 800, in accordance with aspects of this disclosure. In the two embodiments, the first user may be able to easily access or reach portions or regions of the touchscreen that the second user is unable to reach as easily. For example, in FIG. 8A, the first user may be able to easily reach portions of the touchscreen within the reachable region 804 but unable to easily reach portions of the touchscreen within the region 802. Similarly, in FIG. 8B, the second user may be able to easily reach portions of the touchscreen within the reachable region 808 but unable to reach portions of the touchscreen within the region 806. However, for the two different users, the size, shape, and locations of the easily reachable areas may not be the same.

In some embodiments, the touchscreen may include multiple regions that are not easily reached by the user. For example, the user may be unable to reach portions of the touchscreen that are too far from the user's grip location on the device 800, such as the region 802 and 806. However, there may also exist another portion of the touchscreen that is difficult for the user to reach because it is too close to the user's grip location on the device 800. For example, region 803 of FIG. 8A may indicate a region that is difficult for the user's hand 801a to reach because it is too close to the user's hand 801a. Similarly, region 807 of FIG. 8B may indicate a region that is difficult for the user's hand 801b to reach because it is too close to the user's hand 801b.

Accordingly, each of the first and second users of the same device 800 may have differently sized regions of the touchscreen that they are able to easily reach while holding the device 800. Thus, placement of the action elements (e.g., buttons or inputs on the touchscreen) may differ for the different users so as to be within a reachable area for a current user. For example, a user having smaller hands or shorter fingers may have a smaller reachable or easy to reach portion of the touchscreen than a user of the same device having larger hands. Accordingly, after each user performs calibration of the device (e.g., associated with a user profile for each user), the control elements or UI buttons may be placed differently for each user. In some embodiments, tablets or other devices with customizable screens and layouts may utilize calibration with multiple user profiles to allow multiple users to customize their use of the devices. Hence, the device 800 (or processor of device 800, for example processor 205 of FIG. 2B) may generate a plurality of user profiles, for example at least one user profile for each of a first user and a second user, where each of the plurality of user profiles includes information regarding at least one of a grip, orientation, regions of the display (such as various comfort level regions), and one or more control element locations, or any combination thereof. The plurality of user profiles can be stored in a memory, for example memory 230 or storage 275 of FIG. 2B. Since different users may vary in the reachable portions of the touchscreen, the user profile for the first user can include or indicate different control element locations as compared to the user profile for the second user.

However, while the device 800 may be aware of the user's finger or touch object hovering above the touchscreen, the device 800 may not know the reachable area for the user. Therefore, the device 800 may not know where to place the action elements such that they are reachable by the user without the user having to reposition their hand or adjust a grip on the device 800. In order to learn the reachable area for a particular user of the device 800, the device 800 may instruct the user to perform a calibration of the device 800. In some embodiments, the user may request to calibrate the device 800. Such calibration may occur during an initial set-up procedure of the device (e.g., first-time use or after reset). Alternatively, the calibration may occur during feature setup using personalized biometrics or based on a request of the user. By calibrating the device 800, the device 800 may ensure to place the action elements in ergonomic locations (e.g., locations that are easy and comfortable for the user to reach without having to place undue stress on the user).

During the calibration process, the device 800 may prompt the user (e.g., via the touchscreen display) to hold the device 800 using one or more single-or two-handed grips in a desired orientation of the device 800. For example, the device 800 may prompt the user to hold the device 800 in both landscape and portrait orientations with both the left and right-hands (both a left-handed grip and a right-handed grip resulting in a two-handed grip) or with either of the left and right-hands (for a left-handed grip or a right-handed grip). As such the calibration grip (and/or any grip detected after calibration, i.e., a post-calibration grip) can include at least one of a left-handed grip, a right-handed grip, a one-handed grip, a two-handed grip, and/or a mounted grip, or any combination thereof. A left-handed grip or a right-handed grip may also include either a grip that includes palm contact with grip sensors or a grip that does not include palm contact with the grip sensors. In some embodiments, the device 800 may prompt the user to hold the device 800 in the orientation and with the grip that the user will use the most often when holding the device 800. Once the user is holding the device 800 as prompted or as desired, the device 800 may prompt the user to touch the touchscreen with a preferred digit or object at one or more farthest reach points or nearest reach points. In some embodiments, the farthest reach points are the farthest points on the touchscreen that are easily reachable and/or comfortable to reach by the user when holding the device 800. In some embodiments, the nearest reach points are the nearest points on the touchscreen that are easily reachable and/or comfortable to reach by the user when holding the device 800. As the user provides more touches on the touchscreen at the farthest and nearest reach points, the device 800 is able to better calibrate itself to determine a boundary between the reachable area(s) or region(s) of the device 800 and the unreachable area(s) or region(s) of the device 800 to define the reachable area(s). Once the user provides the touches at the farthest and nearest reach points, the device 800 may prompt the user to provide at least one touch within the reachable area to be able to identify the reachable area from the unreachable area. In some embodiments, the device 800 may automatically determine or identify the reachable area as being within an area between the farthest and nearest reach points. In some embodiments, the user's grip of the device 800 may be determined or detected using one or more sensors as described herein (e.g., the grip sensors) in response to the prompting. Based on the grip, the device 800 may save or store the calibration information (e.g., the farthest and nearest reach points or the determined reachable area(s) or region(s)). Accordingly, a single user of the device 800 may have multiple grips of the device 800 stored, each with individual farthest and nearest reach points and reachable area(s) or region(s) information. If the user is unhappy with the calibration or if the user wishes to reset or recalibrate the reachable area(s) or region(s) of the touchscreen, the user can manually request calibration of the device 800 at any time (e.g., by entering a calibration process or mode of the device 800).

Once the device 800 identifies the reachable area or region of the touchscreen, the device 800 may only generate or display action elements in the reachable area. In some embodiments, where action elements are already displayed on the touchscreen, one or more of the action elements may be repositioned within the reachable area. In some embodiments, repositioning or generating the action elements may involve sizing or resizing them so that all action elements fit within the reachable area. In some embodiments, the device 800 repositioning the action elements may comprise moving the action element from a first, pre-calibration location of the touchscreen to a second, post-calibration location within the reachable area, wherein the pre-calibration location is different from the post-calibration location. But for the calibration, the device 800 would have left the action element at the pre-calibration location, which may be difficult for the user to reach.

In some embodiments, the calibration process may generate or determine one or more levels of comfort (e.g., comfort levels) that distinguish or designate different portions of the touchscreen that the user can reach or access with different levels of comfort. For example, a first level of comfort may include any region or portion of the reachable area that the user can reach with no strain or stretching or with any finger or object with a given grip. A second level of comfort may include any region or portion of the reachable area that is only accessible by a particular finger or object (e.g., index finger) when holding the device with the given grip. By generating or identifying different comfort levels, the device may position action elements that are more commonly used within the first comfort level and lesser used action elements in the second comfort level. In some embodiments, the device may learn which action elements are more often or less often used or accessed or which regions or portions of the reachable area are more easily accessed or more difficult to access, etc. Hence the area on the touchscreen reflecting the reachable area bounds a plurality of regions each corresponding to one of a plurality of comfort levels of reachability determined during calibration based on a touch input, for example, detected while performing the calibration of the device. It is also understood that subsequent to a calibration of the device touches during normal use of the device may also be used to refine the definition of the reachable area.

In some embodiments, calibration information may be used in conjunction with information provided by other sensors of the device 800 (e.g., a grip sensor, gyroscope, accelerometer, magnetometer, infrared sensor, ultrasound sensor, proximity sensor, etc.) to more accurately place virtual controls and action elements. For example, an orientation during or after calibration may be computed or determined using a gyroscope, an accelerometer, and/or a magnetometer, which may be referred to as orientation sensors. Determining a grip and/or an orientation, in combination with calibration information, in order to place the virtual controls and actions elements can include any combination of these sensors. By incorporating the calibration described herein, the user experience and interaction with the device 800 is improved based on adding a customized element (e.g., the reachable area determination) to otherwise generic calibration and extrapolation techniques that utilize human biometric averages to guess or estimate the optimal and convenient placement of action elements and virtual controls. Accordingly, pursuant to the disclosure herein, the virtual controls and action elements may be placed based on a combination of all sensor data and calibration information, resulting in buttons and controls always within comfortable and actionable reach by the user.

In some embodiments, the calibration process may allow the device 800 to better determine dimensions of the user's finger pads (i.e., the area of the user's finger that is registered while touching the touchscreen during calibration), for example while detecting a touch input. Using this finger pad size data, the device 800 may better determine the optimal placement of each action element or button. For example, based on the dimensions of the user's finger pads, the device 800 may establish a minimum distance between adjacent action elements or buttons on the touchscreen. Thus, when placing the action elements within the reachable area, the device 800 may ensure that the action elements are placed with reduced risk of the user accidently pressing two buttons at once. Thus, for users with large fingers and a larger finger touch area (e.g., finger pad), the action elements or buttons may be displayed with optimal spacing, with optimal space between each button and placed within the comfortable, reachable area of the user based on calibration (and all the remaining sensors). Similarly, for users with small fingers or a smaller finger touch area (e.g., finger pad) or users of a larger device, the icons may also be optimally placed, with sufficient spacing between action elements and spacing of action elements within the reachable area of the user based on calibration (and all the remaining sensors). Hence, the device 800 may control the spacing between control elements or action elements based on the determined finger pad size. In some embodiments, placement of the action element or button may comprise moving the action element or button to a location within the reachable area from a location outside the reachable area. In some embodiments, a control element may be displayed at a location of the display, as described elsewhere herein, along with at least one additional control element at the location of the display. The device 800 may then control spacing between the control elements based on the determined finger pad size.

In some embodiments, the calibration process may also ensure placement of the at least one control element within the reachable area or at a position that is reachable by the user without adjustment of the user's grip or orientation of the device 800 after calibration is completed, for example without adjustment of a post-calibration grip or post-calibration orientation. For example, once the device 800 is aware of the reachable area for a particular user, the device 800 may know that control elements placed within the reachable area are reachable by the user without adjustment of grip or orientation.

### Use Cases

Two types of use cases are discussed herein. An “idle” use case involves an idle device, (e.g., blank screen or “locked” from interaction), where contextual information may determine tasks available to the user. An “active” use case involves an active device that is “unlocked” or currently being used with an active screen, for example within an application that is already open, where the focus may be on tasks specific to that application.

### Idle Use Cases

Idle use cases may utilize all available data to determine a context for the user's use of the device to present appropriate buttons or action elements (e.g., controls) to the user. In some embodiments, the available data may include (but is not limited to) data from device sensors, date and time information, location information, ambient sounds, proximity information, time-since-last-use, etc.). In all use cases, the device may utilize machine learning to improve its selection of buttons or action elements over time based on a variety of factors (e.g., use over time, time and date, change of behavior, etc.).

In some embodiments, the idle use cases of the device may be initially established by the user. For example, the user may prioritize a specific app for use during travel, while driving, while exercising, or while shopping, etc. Additionally, or alternatively, the user may select different options that are to be available during various activities (e.g., which app controls or phone numbers are available while exercising or driving). In some embodiments, the idle use case may be established by the device via machine learning, which may improve over time as the machine learning continues to advance. For example, when a user first moves to a house in a new city or location, the device may show the maps app (e.g., an action element or button for the maps app) on the idle screen or prioritize the maps app placement on the device. However, after a period of time, the device may identify that the user has learned their location and no longer needs the map app to be prioritized. The device can rely on a simple date duration measurement or deprioritize the map based on the user's reduced use of the map app to navigate their environment.

Examples of idle use cases may include the following, where items displayed during the idle screen or mode during an activity are shown in response to detecting the activity or, additionally or alternatively, the idle screen may display the items during the activity within a reachable area but move the displayed items to a hover location in response to the object hovering above the touchscreen after the device has been calibrated. In the example use cases provided, the device may have been calibrated by the user for use with a single hand. Based on the profile of the user using the device, the apps or buttons related to a particular activity shown below may be different and/or positioning of the buttons may vary (e.g., according to reachable areas, etc.):
On an idle screen or in an idle mode during an <activity>, show <buttons or action element: app or buttons related to an app>
   While Bicycling, show Maps, Fitness Tracker, Geo, Movement, Camera, emergency
   While Running, show Maps, Fitness Tracker, Audio app (music, podcast, etc.), Phone, Emergency
   While Walking, show Maps, Fitness Tracker, Audio app, Phone, Emergency, Camera
   While Grocery Shopping, show Notes/To-Do List, Camera/Gallery, Messaging, Digital Wallet
   While Traveling (trips), show Maps, “AirBnB” or other hospitality marketplace application, Travel Planner, Calendar, Airport/Flights, Transportation
   During a natural disaster in my area (earthquake, flood, tsunami, etc), show Emergency Contacts, Family contacts, Emergency Map, Keypad for calls or messaging

### In-Application or Unlocked Use

The active use cases may be based on tasks and learned behaviors while in an application. In some embodiments, the device may utilize machine learning both in determining initial defaults as well as adjusting over time and context.
Examples of active use cases may include the following, in the following format, where items shown during the in-application or unlocked screen or mode during an activity are shown in response to being in the application or displaying the unlocked screen or, additionally or alternatively, the items may be displayed during the activity within a reachable area but move the displayed items to a hover location in response to the object hovering above the touchscreen after the device has been calibrated:
   While using the Camera, show Mode Switching, Flash control, etc
   While using the Map, show Search, Re-Center, Start/Stop Navigation, Traffic, Transit
   While using the Home screen, show:
      apps used most frequently overall

### Other Considerations

In some embodiments, the circuits, processes, and systems discussed above may be utilized in an apparatus, such as wireless communication device 100. The wireless communication device may be a kind of electronic device used to wirelessly communicate with other electronic devices. Examples of wireless communication devices include cellular telephones, smart phones, Personal Digital Assistants (PDAs), e-readers, gaming systems, music players, netbooks, wireless modems, laptop computers, tablet devices, etc.

The wireless communication device may include one or more image sensors, two or more image signal processors, and a memory including instructions or modules for carrying out the processes discussed above. The device may also have data, a processor loading instructions and/or data from memory, one or more communication interfaces, one or more input devices, one or more output devices such as a display device and a power source/interface. The wireless communication device may additionally include a transmitter and a receiver. The transmitter and receiver may be jointly referred to as a transceiver. The transceiver may be coupled to one or more antennas for transmitting and/or receiving wireless signals.

The wireless communication device may wirelessly connect to another electronic device (e.g., base station). A wireless communication device may alternatively be referred to as a mobile device, a mobile station, a subscriber station, a user equipment (UE), a remote station, an access terminal, a mobile terminal, a terminal, a user terminal, a subscriber unit, etc. Examples of wireless communication devices include laptop or desktop computers, cellular phones, smart phones, wireless modems, e-readers, tablet devices, gaming systems, etc. Wireless communication devices may operate in accordance with one or more industry standards such as the 3rd Generation Partnership Project (3GPP). Thus, the general term “wireless communication device” may include wireless communication devices described with varying nomenclatures according to industry standards.

The functions described herein may be stored as one or more instructions on a processor-readable or computer-readable medium. The term “computer-readable medium” refers to any available medium that can be accessed by a computer or processor. By way of example, and not limitation, such a medium may include random-access memory (RAM), read-only memory (ROM), electrically erasable programmable read-only memory (EEPROM), flash memory or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

As used herein, the term “determining” and/or “identifying” encompass a wide variety of actions. For example, “determining” and/or “identifying” may include calculating, computing, processing, deriving, choosing, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, identifying, establishing, selecting, choosing, determining and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the figures may be performed by corresponding functional means capable of performing the operations.

The methods disclosed herein include one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It should be noted that the terms “couple,” “coupling,” “coupled” or other variations of the word couple as used herein may indicate either an indirect connection or a direct connection. For example, if a first component is “coupled” to a second component, the first component may be either indirectly connected to the second component or directly connected to the second component. As used herein, the term “plurality” denotes two or more. For example, a plurality of components indicates two or more components.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

In the foregoing description, specific details are given to provide a thorough understanding of the examples. However, it will be understood by one of ordinary skill in the art that the examples may be practiced without these specific details. For example, electrical components/devices may be shown in block diagrams in order not to obscure the examples in unnecessary detail. In other instances, such components, other structures and techniques may be shown in detail to further explain the examples.

Headings are included herein for reference and to aid in locating various sections. These headings are not intended to limit the scope of the concepts described with respect thereto. Such concepts may have applicability throughout the entire specification.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

The previous description of the disclosed implementations is provided to enable any person skilled in the art to make or use the present disclosure. Various modifications to these implementations will be readily apparent to those skilled in the art, and the generic principles defined herein may be applied to other implementations without departing from the spirit or scope of the disclosure. Thus, the present disclosure is not intended to be limited to the implementations shown herein but is to be accorded the widest scope consistent with the principles and novel features disclosed herein.

What is claimed is:

1. A method, operable by a device, of placing a virtual control on a touch-sensitive display of the client device, the method comprising:
performing a calibration of the device to facilitate ergonomic placement of at least one control element associated with the virtual control on the display, wherein the performing of the calibration comprises:
prompting a user of the device to hold the device in a calibration orientation,
detecting a calibration grip while the device is in the calibration orientation during the calibration subsequent to the prompting the user to hold the device,
prompting the user to touch a region of the display while maintaining the calibration orientation and the calibration grip, and
detecting a touch input within the region subsequent to the prompting the user to touch the region of the display; and
subsequent to the performing the calibration of the device:
detecting a post-calibration grip on the device; and
displaying the at least one control element at a location of the display, wherein the location is based on the performed calibration and the detected post-calibration grip.

2. The method of claim 1, wherein the performing of the calibration comprises determining an ergonomic reachable area on the display associated with the calibration while the device is in the calibration orientation based on the detected touch input.

3. The method of claim 2, wherein the displaying the at least one control element at the location of the display comprises placing the at least one control element to ensure that the at least one control element is reachable without adjustment of a post-calibration orientation or the post-calibration grip.

4. The method of claim 2, wherein the displaying the at least one control element at the location comprises positioning the at least one control element in the location of the display, wherein the location differs from a pre-calibration location of the at least one control element where the at least one control element would have otherwise been positioned but for the calibration.

5. The method of claim 1, wherein the calibration grip and/or the post-calibration grip include at least one of a left-handed grip, a right-handed grip, a one-handed grip, a two-handed grip, and/or a mounted grip, or any combination thereof; and wherein the left-handed grip or the right-handed grip includes a grip that includes palm contact with the device or a grip that does not include palm contact with the device.

6. The method of claim 1, further comprising detecting a post-calibration orientation of the device after performing the calibration, wherein the displaying the at least one control element is further based on the detected post-calibration orientation.

7. The method of claim 1, further comprising:
detecting an object that generates the touch input within a distance above the display at a hover location;
determining that the object is within the distance above the display for a threshold period of time; and
repositioning the displayed at least one control element at the location of the display to the hover location.

8. The method of claim 1, wherein prompting the user to touch a region of the display comprises prompting the user to touch the region of the display at at least one of a farthest reach point or a nearest reach point while maintaining the calibration grip on the device.

9. The method of claim 1, wherein performing a calibration of the device comprises performing a calibration of the device for each of a first user and a second user and wherein the method further comprises:
generating user profiles for each of the first user and the second user, each user profile including information regarding at least one of a grip, an orientation, one or more regions of the display, and one or more control element locations, or any combination thereof; and
storing the user profiles in a memory.

10. The method of claim 1, wherein the performing of the calibration further comprises:
determining a finger pad size when detecting the touch input; and
displaying at least one additional control element at the location of the display; and
controlling spacing between the control elements based on the determined finger pad size.

11. An apparatus configured to place a virtual control on a touch-sensitive display of a client device, the apparatus comprising:
at least one sensor configured to detect one or more inputs based on a user's grip and orientation of the device;
a processor configured to perform a calibration of the device to facilitate ergonomic placement of at least one control element associated with the virtual control on the display, wherein the processor is configured to at least:
prompt the user of the device to grip the device in a calibration orientation,
determine a calibration grip, based on the one or more inputs detected by the at least one sensor, while the device is in the calibration orientation during the calibration subsequent to the prompt of the user to grip the device,
prompt the user to touch a region of the display while maintaining the calibration orientation and the calibration grip,
detect a touch input within the region subsequent to the prompt of the user to touch the region of the display,
detect a post-calibration grip on the device subsequent to the calibration of the device, and
display the at least one control element at a location of the display, wherein the location is based on the performed calibration and the detected post-calibration grip.

12. The apparatus of claim 11, wherein the processor is further configured to determine a reachable area on the display associated with the calibration while the device is in the calibration orientation based on the detected touch input.

13. The apparatus of claim 12, wherein the reachable area bounds a plurality of regions each corresponding to one of a plurality of comfort levels of reachability based on the detected touch input.

14. The apparatus of claim 12, wherein the processor configured to display the at least one control element at the location of the display comprises the processor configured to place the at least one control element to ensure that the at least one control element is reachable without adjustment of a post-calibration orientation or the post-calibration grip.

15. The apparatus of claim 12, wherein the processor configured to display the at least one control element at the location comprises the processor configured to position the at least one control element in the location of the display, wherein the location differs from a pre-calibration location of the at least one control element where the at least one control element would have otherwise been positioned but for the calibration.

16. The apparatus of claim 11, wherein the display comprises a plurality of touch sensitive elements that each corresponds to a single location of the display.

17. The apparatus of claim 11, wherein the calibration grip and/or the post-calibration grip include at least one of a left-handed grip, a right-handed grip, a one-handed grip, a two-handed grip, and/or a mounted grip, or any combination thereof; and wherein the left-handed grip or the right-handed grip includes a grip that includes palm contact with the device or a grip that does not include palm contact with the device.

18. The apparatus of claim 11, wherein the processor is further configured to detect a post-calibration orientation of the device after performing the calibration, wherein the processor is configured to display the at least one control element based on the detected post-calibration orientation.

19. The apparatus of claim 18, wherein the grip and the orientation are detected based at least in part on at least one of a grip sensor, a gyroscope, an accelerometer, a magnetometer, an infrared sensor, an ultrasound sensor, and/or a proximity sensor, or any combination thereof

20. The apparatus of claim 11, wherein the calibration is performed during an initial setup of the device or based on a request from the user or a software operating on the device.

21. The apparatus of claim 11, wherein the processor is further configured to:
detect an object that generates the touch input within a distance above the display at a hover location;
determine that the object is within the distance above the display for a threshold period of time; and
reposition the displayed at least one control element at the location of the display to the hover location.

22. The apparatus of claim 11, wherein the at least one control element is associated with a displayed user interface (UI) element of the mobile device touchscreen which activates an action when a touch is received at the location.

23. The apparatus of claim 11, wherein processor configured to prompt the user to touch a region of the display comprises the processor configured to prompt the user to touch the region of the display at at least one of a farthest reach point or a nearest reach point while maintaining the calibration grip on the device.

24. The apparatus of claim 11, wherein the processor configured to perform a calibration of the device comprises the processor configured to perform a calibration of the device for each of at least a first user and a second user and wherein the processor is further configured to:
generate a plurality of user profiles for each of the first user and the second user, each user profile including information regarding at least one of a grip, an orientation, one or more regions of the display, and one or more control element locations, or any combination thereof; and
store the plurality of user profiles in a memory.

25. The apparatus of claim 24, wherein the at least one user profile for the first user includes different control element locations as compared to the at least one user profile for the second user.

26. The apparatus of claim 11, wherein the processor is further configured:
determine a finger pad size when detecting the touch input; and
display at least one additional control element at the location of the display; and
control spacing between the control elements based on the determined finger pad size.

27. An apparatus configured to place a virtual control on a touch-sensitive display of a client device, the apparatus comprising:
means for performing a calibration of the device to facilitate ergonomic placement of at least one control element associated with the virtual control on the display;
means for prompting a user of the device to hold the device in a calibration orientation;
means for detecting a calibration grip while the device is in the calibration orientation during the calibration subsequent to the prompting the user to hold the device;
means for prompting the user to touch a region of the display while maintaining the calibration orientation and the calibration grip;
means for detecting a touch input within the region subsequent to the prompting the user to touch the region of the display;
means for detecting a post-calibration grip on the device; and
means for displaying the at least one control element at a location of the display, wherein the location is based on the performed calibration and the detected post-calibration grip.

28. The apparatus of claim 27, wherein the calibration is performed during an initial setup of the device or based on a request from the user or a software operating on the device.

29. The apparatus of claim 27, further comprising:
means for detecting an object that generates the touch input within a distance above the means for displaying at a hover location;
means for determining that the object is within the distance above the means for displaying for a threshold period of time; and
means for repositioning the displayed at least one control element at the location of the means for displaying to the hover location.

30. A non-transitory, computer-readable storage medium, comprising code executable to:
perform a calibration of the device to facilitate ergonomic placement of at least one control element associated with the virtual control on the display;
prompt a user of the device to hold the device in a calibration orientation;
detect a calibration grip while the device is in the calibration orientation during the calibration subsequent to the prompting the user to hold the device;
prompt the user to touch a region of the display while maintaining the calibration orientation and the calibration grip;
detect a touch input within the region subsequent to the prompting the user to touch the region of the display;
detect a post-calibration grip on the device; and
display the at least one control element at a location of the display, wherein the location is based on the performed calibration and the detected post-calibration grip.
